(19) United States
(12) Patent Application Publication
(10) Pub. No.: US 2009/0298340 A1
(43) Pub. Date: Dec. 3, 2009

(54) COMMON MODULE FOR TAB UP TYPE AND TAB DOWN TYPE NETWORK CONNECTOR

(75) Inventor: Chang-Yi Li, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: SPEED TECH CORP., Taoyuan Hsien (TW)

(21) Appl. No.: 12/128,630

(22) Filed: May 29, 2008

(51) Int. Cl. H01R 13/66

(52) U.S. Cl. 439/620.22

(57) ABSTRACT

A common module for a Tab up type and Tab down type network connector suitable for being assembled with a Tab up type or a Tab down type insulating housing, a circuit board, and a terminal set electrically connected to the circuit board to form a Tab up type or a Tab down type network connector is provided. The Tab up type or a Tab down type insulating housing has a receptacle hole and a receiving slot at its front side and back side, respectively. The common module includes a filter module, a baffle, and a shielding casing. The filter module is disposed within the receiving slot of the insulating housing. The circuit board is disposed above the filter module. The baffle covers the back side of the insulating housing. The shielding casing covers the periphery of the insulating housing and exposes the receptacle hole.

### BACKGROUND OF THE INVENTION

1. Field of the Invention

The present invention relates to a network connector, and in particular, to a common module of a Tab up type and Tab down type network connector.

2. Description of Related Art

With the continuous development of technology, information and data transmission needs a high speed network. However, although the complete network layouts and facilities are established, the quality and efficiency of network transmission still cannot be sufficiently guaranteed. Therefore, it has become one of the most important topics for today's network development how to guarantee the network data and information transmission quality. Generally speaking, the actual communication system includes a transmission medium, a connector, etc. The transmission medium may be, among other things, a twisted pair cable, a coaxial cable, an optical fiber, or microwave.

Based on the requirements of line coupling, connectors for coupling signal lines have been one of the important components. Here, the connectors may be fabricated into various forms, such as an interface card connector, a network cable connector, a coaxial cable connector, a telephone line connector, and an optical fiber connector, in order to meet the requirements of various types of transmission media.

Generally speaking, an RJ-45 connector commonly serves as a network cable connector, and its mating plug usually has 8 slots or 8 contacts. The RJ-45 connector usually has a rate of 10 Mbps, 100 Mbps, 1 Gbps or more in network transmission. Therefore, for example, data in a computer may be transmitted to other computers through network cables, so as to achieve data sharing or data integration.

Furthermore, the RJ-45 connectors may be classified into Tab up type and Tab down type depending on how they are disposed on the external devices, such as circuit boards. In detail, the insulating housing of the connector has a fool-proofing groove, corresponding to the inserting portion of the plug of the RJ-45 type network cable. The fool-proofing groove for a Tab up type network connector is located above the receptacle hole for receiving insertion of the RJ-45 type network cable plug, whereas the fool-proofing groove of a Tab down type network connector is located beneath the receptacle hole.

Due to the different positions of the fool-proofing grooves in the insulation housing, different types of filter modules and circuit boards must be prepared accordingly in manufacturing the Tab up type or Tab down type network connector, and thus the assembly of the two different types of network connectors is able to be completed. In view of the above, the Tab up type and Tab down type network connector have no common parts, and the burden of inventory of those parts is heavy, thus leading to a higher inventory cost.

### SUMMARY OF THE INVENTION

The present invention is directed to a common module for a Tab up type and Tab down type network connector, which is formed by integrating common elements in the Tab up type and Tab down type network connector, thereby reducing the cost of inventory.

The present invention provides a common module for a Tab up type and Tab down type network connector, which is suitable for being assembled with a Tab up type or a Tab down type insulating housing, a circuit board, and a terminal set electrically connected to the circuit board to form a Tab up type or a Tab down type network connector. The Tab up type or Tab down type insulating housing has a receptacle hole and a receiving slot at its front side and back side, respectively. The receptacle hole receives insertion of a plug of an external network cable, and the terminal set is disposed within the receptacle hole to form an electrical connection with the network cable plug. The common module includes a filter module, a baffle, and a shielding casing. The filter module is suitable for being disposed within the receiving slot of the Tab up type or Tab down type insulating housing. The circuit board is disposed between the filter module and the receiving slot of the insulating housing. The baffle covers the back side of the Tab up type or Tab down type insulating housing. The shielding casing substantially covers a periphery of the Tab up type or Tab down type insulating housing and exposes the receptacle hole.

In an embodiment of the present invention, the filter module includes a frame, a filter terminal set, and a plurality of filter elements. The frame has a plurality of vertical terminal channels. The filter terminal set is disposed within the terminal channels. The filter elements are disposed within the frame, and form an electrical connection with the circuit board through the filter terminal set.

In an embodiment of the present invention, the circuit board is disposed above the filter module. Thus, in the Tab up type network connector, the terminal set forms an electrical connection with the circuit board through the filter terminal set of the filter module, and is located on a lower end surface of the receptacle hole. In the Tab down type network connector, however, the terminal set directly forms an electrical connection with the circuit board, and is located on an upper end surface of the receptacle hole.

In an embodiment of the present invention, the baffle and the shielding casing respectively have a first joining member and a second joining member corresponding to the first joining member, so as to fix the baffle on the shielding casing through the combination of the first and second joining members.

In an embodiment of the present invention, the filter module includes a frame, a plurality of filter elements, and a filter terminal set. The frame has a plurality of terminal channels. The filter elements are disposed within the frame. The filter terminal set is disposed within the terminal channels. The above filter element is electrically connected to the circuit board through the filter terminal set.

In an embodiment of the present invention, the baffle is made of a metal material.

In an embodiment of the present invention, the shielding casing is made of a metal material.

In an embodiment of the present invention, the common module further includes an LED indicator lamp disposed within the Tab up type or Tab down type insulating housing. The LED indicator lamp is electrically connected to the circuit board and exposed from the insulating housing.

The common module for a Tab up type and Tab down type network connector according to the present invention is formed by mainly integrating the common elements in the Tab up type and Tab down type network connector. The common module may be assembled with different types of insulating housings to form a Tab up type network connector or a Tab down type network connector. Therefore, this design enhances the common usage of elements in Tab up type and Tab down type network connectors, thereby reducing the burden of inventory.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates an exploded three-dimensional view of a common module for a Tab up type and Tab down type network connector according to an embodiment of the present invention.

FIG. 2A illustrates a schematic three-dimensional view of a Tab up type network connector formed by the common module shown in FIG. 1 assembled with a Tab up type insulating housing.

FIG. 2B illustrates a schematic three-dimensional view of a Tab down type network connector formed by the common module shown in FIG. 1 assembled with a Tab down type insulating housing.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

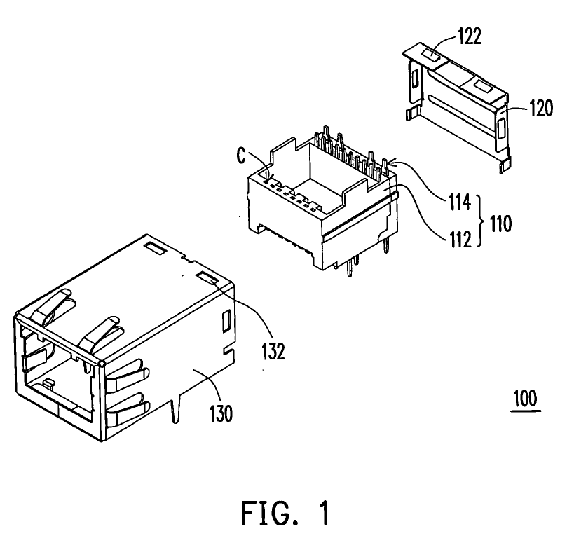

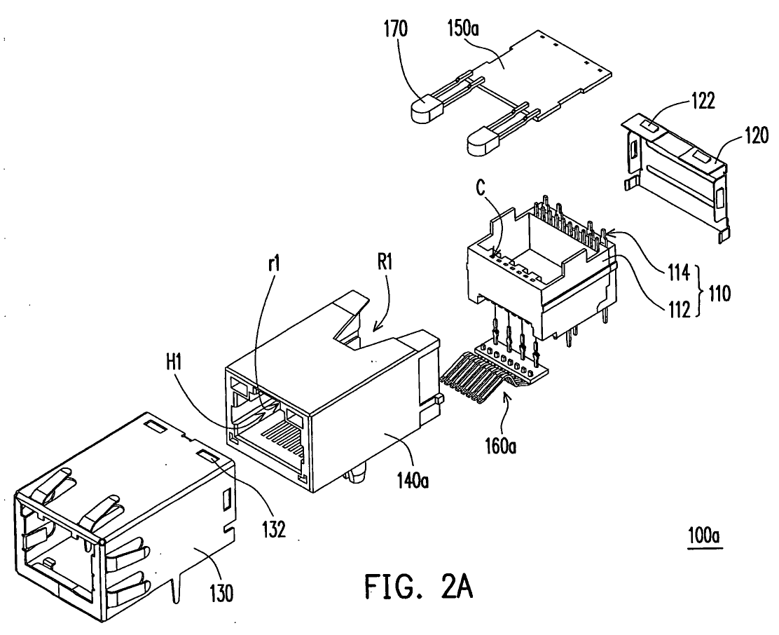

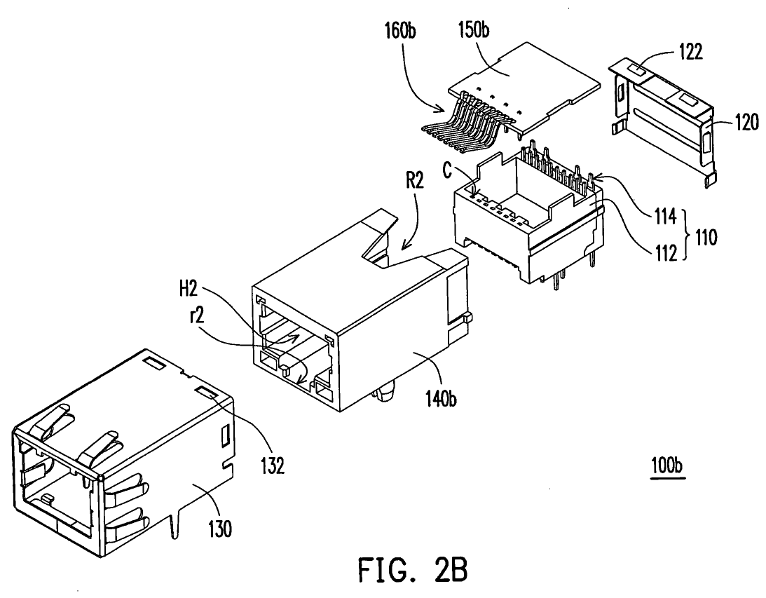

FIG. 1 illustrates an exploded three-dimensional view of a common module for a Tab up type and Tab down type network connector according to an embodiment of the present invention. FIG. 2A illustrates a schematic three-dimensional view of a Tab up type network connector formed by the common module shown in FIG. 1 assembled with a Tab up type insulating housing. FIG. 2B illustrates a schematic three-dimensional view of a Tab down type network connector formed by the common module shown in FIG. 1 assembled with a Tab down type insulating housing. The elements included in the common module and the connection relations of the assembly of the common module and the Tab Up type and Tab down type insulating housing will be described below with reference to the drawings.

First, referring to FIGS. 1 and 2A together, the common module 100 is suitable for being assembled with a Tab up type insulating housing 140a, a circuit board 150a, and a terminal set 160a electrically connected to the circuit board 150a to form a Tab up type network connector 100a. As shown in FIG. 2A, the Tab up type insulating housing 140a has a receptacle hole H1 and a receiving slot R1 at its front side and back side, respectively. The receptacle hole H1 is used for receiving insertion of a network cable plug such as a RJ-45 type network cable plug. Further, a fool-proof groove r1 of the Tab up type network connector is located above the receptacle hole H1 for receiving insertion of the RJ-45 type network cable plug. In addition, the terminal set 160a is disposed within the receptacle hole H1 to form an electrical connection with the network cable plug.

Next, referring to FIGS. 1 and 2B together, the common module 100 is suitable for being assembled with a Tab down type insulating housing 140b, a circuit board 150b, and a terminal set 160b electrically connected to the circuit board 150b to form a Tab down type network connector 100b. Likewise, as shown in FIG. 2B, the Tab down type insulating housing 140b has a receptacle hole H2 and a receiving slot R2 at its front side and back side, respectively. The receptacle hole H2 is used for receiving insertion of the RJ-45 type network cable plug. Furthermore, a fool-proof groove r2 of the Tab down type network connector is located beneath the receptacle hole H2 for receiving insertion of the RJ-45 type network cable plug. The circuit boards 150a and 150b of the Tab up type network connector 100a and the Tab down type network connector 100b have different designs when being assembled with different insulating housing structures. Likewise, the terminal set 160b is disposed within the receptacle hole H2 to form an electrical connection with the network cable plug.

Referring to FIGS. 1 and 2A together, the common module 100 mainly includes a filter module 110, a baffle 120, and a shielding casing 130. The filter module 110 is suitable for being disposed within the receiving slot R1 of the Tab up type insulating housing 140a to filter noises of the signal. Furthermore, the filter module 110 includes a frame 112, a plurality of filter elements (not shown) within the frame 112, and a filter terminal set 114. The frame 112 has a plurality of vertical terminal channels C. The filter terminal set 114 is disposed within the above terminal channels C. The filter elements are disposed within the frame 112 and form an electrical connection with the circuit board 150a through the filter terminal set 114. The circuit board 150a is disposed between the filter module 110 and the receiving slot R1 of the Tab up type insulating housing 140a. In this embodiment, the terminal set 160a forms an electrical connection with the circuit board 150a through the filter terminal set 114 of the filter module 110, and is located on the lower end surface of the receptacle hole H1.

The baffle 120 covers the back side of the Tab up type insulating housing 140a for preventing dust or foreign substances from entering the network connector 100a. In an embodiment of the present invention, the baffle 120 is made of a metal material for achieving the electromagnet shielding effect. The shielding casing 130 substantially covers the periphery of the entire Tab up type insulating housing 140a and exposes the receptacle hole H1 of the insulating housing 140a. Likewise, the shielding casing 130 is preferably made of a metal material for providing the electromagnet shielding effect. Furthermore, a first joining member 122 and a second joining member 132 corresponding to the first joining member 122 are respectively disposed on the baffle 120 and the shielding casing 130, so as to fix the baffle 120 on the shielding casing 130 through the combination of the first joining member 122 and the second joining member 132. In this embodiment, the first joining member 122 is a protrusion and the second joining member 132 is an opening. When assembling the shielding casing 130 with the baffle 120, the positioning of the two can be achieved by simply inserting the protrusion into the opening.

In addition, an LED indicator lamp 170 is optionally disposed in the Tab up type network connector 100a. The LED indicator lamp 170 is electrically connected to the circuit board 150a, disposed within the Tab up type insulating housing 140a, and exposed from the insulating housing 140a, so as to show the current transmission status.

Referring to FIG. 2B, the elements in the Tab down type network connector 100b are disposed in substantially the same way as those of the Tab up type network connector 100a, except that in the Tab down type network connector 100b, the terminal set 160b directly forms an electrical connection with the circuit board 150b and is located on the upper end surface of the receptacle hole H2.

In the above embodiments, a single network connector is described by way of example. However, the common module may also be applied in an 1×N (in the form of serially connected N network connectors) network connector, thus enhancing the common usage of the elements in the Tab up type and Tab down type network connector, and the achieving the purpose of reducing the burden of inventory.

To sum up, the common module for a Tab up type and Tab down type network connector according to the present invention is mainly formed by integrating the common elements i.e. a filter module, a baffle, and a shielding casing in the Tab up type and Tab down type network connector, thereby enhancing the common usage of the elements in the Tab up type and Tab down type network connector and reducing the burden of inventory.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A common module for a Tab up type and Tab down type network connector suitable for being assembled with a Tab up type or a Tab down type insulating housing, a circuit board, and a terminal set electrically connected to the circuit board to form a Tab up type or a Tab down type network connector, wherein the Tab up type or Tab down type insulating housing comprises a receptacle hole and a receiving slot at its front side and a back side respectively, the receptacle hole receives insertion of an external network cable plug, the terminal set is disposed within the receptacle hole to form an electrical connection with the external network cable plug, the common module comprising:
a filter module, suitable for being disposed within the receiving slot of the Tab up type or Tab down type insulating housing, the circuit board being disposed between the filter module and the receiving slot of the insulating housing;
a baffle, covering the back side of the Tab up type or Tab down type insulating housing; and
a shielding casing, substantially covering a periphery of the Tab up type or Tab down type insulating housing, and exposing the receptacle hole.

2. The common module for a Tab up type and Tab down type network connector according to claim 1, wherein the filter module comprises:
a frame, comprising a plurality of vertical terminal channels;
a filter terminal set, disposed within the terminal channels; and
a plurality of filter elements, disposed within the frame and forming an electrical connection with the circuit board through the filter terminal set.

3. The common module for a Tab up type and Tab down type network connector according to claim 1, wherein the circuit board is disposed above the filter module, such that in the Tab up type network connector, the terminal set forms an electrical connection with the circuit board through the filter terminal set of the filter module and is located on a lower end surface of the receptacle hole; and in the Tab down type network connector, the terminal set directly forms an electrical connection with the circuit board and is located on an upper end surface of the receptacle hole.

4. The common module for a Tab up type and Tab down type network connector according to claim 1, wherein the baffle and the shielding casing respectively comprise a first joining member and a second joining member corresponding to the first joining member, so as to fix the baffle on the shielding casing through the combination of the first joining member and the second joining member.

5. The common module for a Tab up type and Tab down type network connector according to claim 1, wherein the baffle is made of a metal material.

6. The common module for a Tab up type and Tab down type network connector according to claim 1, wherein the shielding casing is made of metal.

7. The common module for a Tab up type and Tab down type network connector according to claim 1, further comprising an LED indicator lamp disposed within the Tab up type or Tab down type insulating housing, the LED indicator lamp being electrically connected to the circuit board and exposed from the insulating housing.
